(19) United States
(12) Patent Application Publication
(10) Pub. No.: US 2026/0264845 A1
(43) Pub. Date: Sep. 10, 2026

(54) FLIGHT CONTROL SYSTEM AND METHOD FOR AN AIRCRAFT

(71) Applicant: Airbus Operations SAS, TOULOUSE (FR)

(72) Inventors: Ismaël DOUKALI, BLAGNAC (FR); Camila FRAGA SERAFIM, TOULOUSE (FR)

(21) Appl. No.: 19/558,955

(22) Filed: Mar. 6, 2026

(30) Foreign Application Priority Data
Mar. 10, 2025 (FR) FR2502357

(51) Int. Cl. B64C 13/50; B64C 13/08; B64C 13/18; G05D 1/49; G05D 109/22

(52) U.S. Cl. CPC B64C 13/505; B64C 13/08; B64C 13/18; G05D 1/49; G05D 2109/22

(57) ABSTRACT

A flight control system having primary flight control computers and secondary flight control computers. Each secondary computer is configured to: determine if a situation is confirmed, in which no primary computer is functional, the secondary computer receives valid anemo-inertial information from the aircraft and the secondary computer has not received a piloting command originating from a piloting component, for at least a predetermined duration. When the situation is confirmed, the secondary flight control computer activates a piloting mode and is configured to: determine roll and pitch angles based on anemo-inertial information from the aircraft; compute control commands for control surface actuators connected to the secondary computer in order to keep the aircraft flat and at constant altitude; and control the control surface actuators connected to the secondary computer based on the computed commands. Also a method for flight control of an aircraft.

### CROSS-REFERENCES TO RELATED APPLICATIONS

This application claims the benefit of French Patent Application Number FR2502357 filed on Mar. 10, 2025, the entire disclosure of which is incorporated herein by way of reference.

### FIELD AND BACKGROUND OF THE INVENTION

The invention relates to the field of flight controls for aircraft. A flight control system is the link between the piloting components (for example, a stick or a mini-stick in the cockpit) and the aerodynamic control surfaces of the aircraft. The flight control system comprises a set of flight control computers that determine, based on information received from the various piloting components, the commands to be applied to the control surface actuators. These flight control computers comprise a set of primary flight control computers (PRIM), a set of secondary flight control computers (SEC) and a backup computer. The primary computers are designed to implement automatic piloting laws of the aircraft. The secondary computers are not generally provided for implementing such automatic piloting laws. In an example illustrated by document FR 2943036, the set of primary flight control computers comprises three computers PRIM1, PRIM2, PRIM3 and the set of secondary flight control computers comprises three computers SEC1, SEC2, SEC3. The control surface actuators, as well as the sensors associated with these actuators, are generally connected to the primary and secondary flight control computers, via controllers for said control surface actuators. In normal operation, a primary computer computes the commands to be applied to the control surfaces and applies these commands to the corresponding control surface actuators, generally via the controllers for said control surface actuators. More specifically, in normal operation, the primary computer PRIM1 computes the commands to be applied to all the control surfaces. In the event of a fault in the computer PRIM1, the computer PRIM2 takes over and if it is faulty then the computer PRIM3 takes over. When all the primary computers are faulty, the secondary computers take over. Each secondary computer then applies the commands it determines to the control surface actuators connected thereto. If the aircraft was in an automatic piloting mode, this automatic piloting mode is then deactivated since the secondary computers are not designed to implement automatic piloting laws. The aircraft then transitions to manual piloting mode.

In the event of the loss of all the primary computers, the control surface actuators are controlled by the secondary computers, with each secondary computer controlling the control surface actuators connected thereto. If, in addition, one or two secondary computers is/are no longer operational, the control surface actuators connected to this or these secondary computers are no longer controlled. These actuators are then in a mode, called damped mode. Some control surfaces then may no longer be controlled by the flight control system. However, the various control surface actuators are distributed between the various secondary computers in such a way that the aircraft still can be controlled by a pilot even if only one secondary computer remains operational, which computer receives the commands from the pilot (particularly entered by means of a stick or a mini-stick in the cockpit).

When aircraft are operating, at least one pilot is expected to be permanently present in the cockpit, so that this pilot can control the aircraft in manual piloting mode in the aforementioned situation. If, in exceptional circumstances, this pilot becomes unavailable (incapacitated situation, etc.) then the secondary computers would no longer receive manual piloting commands. In this case, the one or more secondary computers that remain operational continue to apply the last control surface commands that they applied before the failure situation. However, these commands may not be sufficient to counter the effects of control surfaces that are no longer controlled by other secondary computers. Indeed, uncontrolled control surfaces generally return to their zero hinge moment position by positioning themselves in the aerodynamic flow of the air and can act on the roll or pitch angles of the aircraft. Therefore, preventing the actions of the uncontrolled control surfaces from resulting in a risk of the aircraft leaving its flight domain is desirable.

### SUMMARY OF THE INVENTION

The present invention is notably intended to provide a solution to this problem. It relates to a flight control system for an aircraft comprising a set of primary flight control computers and a set of secondary flight control computers, wherein each secondary flight control computer is configured to receive operating information from each primary flight control computer, anemo-inertial information from the aircraft and piloting commands originating from at least one piloting component of the aircraft.

According to the invention, each secondary flight control computer is configured to:
determine whether a situation is confirmed, in which:
   none of the primary flight control computers is functional;
   said secondary flight control computer receives valid anemo-inertial information from the aircraft; and
   said secondary flight control computer has not received a piloting command originating from the at least one piloting component of the aircraft, for at least a predetermined duration;
if said situation is confirmed, activate a piloting mode of the aircraft, in which said secondary flight control computer is configured to:
   acquire anemo-inertial information from the aircraft;
   determine roll and pitch angles of the aircraft based on said anemo-inertial information from the aircraft;
   compute control commands for control surface actuators of the aircraft connected to this secondary flight control computer so as to maintain the roll and pitch angles of the aircraft at zero values in order to keep the aircraft flat and at constant altitude; and
   control the control surface actuators connected to this secondary flight control computer based on the computed commands.

Thus, when uncontrolled control surfaces (in particular control surfaces whose actuators are connected to another secondary flight control computer that is unavailable) act on the roll and/or pitch angles of the aircraft, the actions of said control surfaces are countered by activating said piloting mode of the considered secondary flight control computer, which to this end controls other control surfaces of the aircraft. This allows the aircraft to be kept substantially flat and at constant altitude and therefore allows the aircraft to be kept in its flight domain even in the absence of piloting commands given by a pilot.

In one embodiment, the secondary flight control computer is further configured to deactivate said mode for piloting the aircraft after activating it, if it receives at least one piloting command originating from the at least one piloting component of the aircraft.

In one embodiment, said anemo-inertial information from the aircraft comprises at least one current altitude and one current roll angle of the aircraft, and the secondary flight control computer is configured to:
store a reference altitude corresponding to a current altitude of the aircraft when said piloting mode is activated;
compute a deviation in altitude corresponding to a difference between the current altitude of the aircraft and the reference altitude;
compute a deviation in roll angle corresponding to a difference between the current roll angle of the aircraft and a zero roll angle reference value;
compute the control commands for the control surface actuators of the aircraft in the form of pitch commands and roll commands of the aircraft based on said deviations in altitude and in roll angle, respectively.

Advantageously, the pitch and roll commands are computed by the secondary flight control computer so as to be homogeneous with piloting commands likely to be issued by the at least one piloting component of the aircraft and the secondary flight control computer is configured to apply the pitch and roll commands thus computed to an input of a control chain of said secondary flight control computer intended to receive piloting commands originating from at least one piloting component of the aircraft.

In a particular embodiment, the secondary flight control computer is configured to compute the pitch commands taking into account a corrective term intended to control a zero pitch speed of the aircraft.

Again advantageously, the secondary flight control computer is configured to limit each of the computed pitch commands and roll commands between a minimum value and a maximum value, with these minimum and maximum values respectively corresponding to permissible minimum and maximum limits of values of piloting commands originating from the at least one piloting component of the aircraft.

The invention also relates to a flight control method for an aircraft, comprising a flight control system comprising a set of primary flight control computers and a set of secondary flight control computers, wherein each secondary flight control computer is configured to receive operating information from each primary flight control computer, anemo-inertial information from the aircraft and piloting commands originating from at least one piloting component of the aircraft.

The method comprises the following steps implemented by each secondary flight control computer:
determining whether a situation is confirmed, in which:
   none of the primary flight control computers is functional;
   said secondary flight control computer receives valid anemo-inertial information from the aircraft; and
   said secondary flight control computer has not received a piloting command originating from the at least one piloting component of the aircraft, for at least a predetermined duration;
if said situation is confirmed, activating a piloting mode for the aircraft comprising the following steps:
   acquiring anemo-inertial information from the aircraft;
   determining roll and pitch angles of the aircraft based on said anemo-inertial information from the aircraft;
   computing control commands for control surface actuators of the aircraft connected to this secondary flight control computer so as to maintain the roll and pitch angles of the aircraft at zero values in order to keep the aircraft flat and at constant altitude; and
   controlling the control surface actuators connected to this secondary flight control computer based on the computed commands.

In one embodiment, said anemo-inertial information from the aircraft comprises at least one current altitude and one current roll angle of the aircraft and the method comprises the following steps implemented by the secondary flight control computer:
storing a reference altitude corresponding to a current altitude of the aircraft when said piloting mode is activated;
computing a deviation in altitude corresponding to a difference between the current altitude of the aircraft and the reference altitude;
computing a deviation in roll angle corresponding to a difference between the current roll angle of the aircraft and a zero roll angle reference value;
computing the control commands for the control surface actuators of the aircraft in the form of pitch commands and roll commands of the aircraft based on said deviations in altitude and in roll angle, respectively.

In a particular embodiment, the step of computing the actuator control commands comprises computing the pitch commands taking into account a corrective term intended to control a zero pitch speed of the aircraft.

The invention also relates to an aircraft comprising a flight control system as mentioned above.

### BRIEF DESCRIPTION OF THE DRAWINGS

The invention will be better understood upon reading the following description and with reference to the appended figures.

FIG. 1 illustrates an aircraft equipped with a flight control system according to one embodiment of the invention.

FIG. 2 schematically illustrates a flight control system according to one embodiment of the invention.

FIG. 3 illustrates a flight control method according to one embodiment of the invention.

### DETAILED DESCRIPTION OF THE PREFERRED EMBODIMENTS

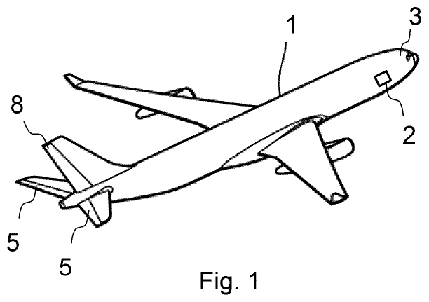

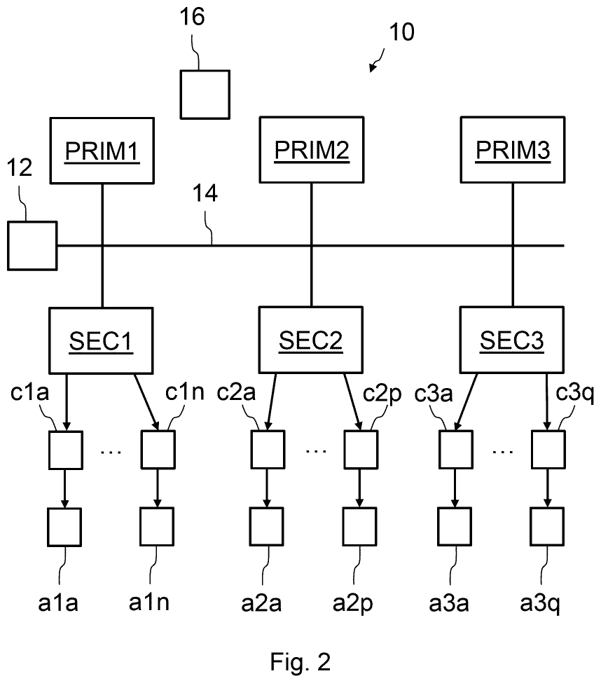

The flight control system 10 shown in FIG. 2 comprises a set of primary flight control computers PRIM1, PRIM2, PRIM3, as well as a set of secondary flight control computers SEC1, SEC2, SEC3 for an aircraft, such as the aircraft 1 shown in FIG. 1. These various computers are connected to an avionics communication network 14, for example, according to the ARINC 429 standard or to the ARINC 664 standard, part 7. A set of information sources 12 is also connected to the avionics communication network 14. This set of information sources 12 notably comprises at least one anemo-inertial information source for the aircraft, for example, of the ADIRU (Air Data and Inertial Reference Unit) type. The various primary and secondary computers are also connected to at least one piloting component 16 such as a stick or a mini-stick placed in a cockpit 3 of the aircraft. For the sake of the clarity of the figure, the connections between the computers and the piloting component 16 are not shown. Each of the secondary flight control computers is connected to a set of control surface actuator controllers of the aircraft. Thus, the computer SEC1 is connected to a set of control surface controllers c1a . . . c1n provided to control respective control surface actuators a1a . . . a1n, the computer SEC2 is connected to a set of control surface controllers c2a . . . c2p provided for controlling respective control surface actuators a2a . . . a2p and the computer SEC3 is connected to a set of control surface controllers c3a . . . c3q provided for controlling respective control surface actuators a3a . . . a3q. These control surface actuators are designed to control the control surfaces of the aircraft 1 such as elevators 5, a rudder 8 or even control surfaces not shown in detail in FIG. 1, such as spoilers, flaps, etc., associated with the wings of the aircraft. The primary and secondary flight control computers are installed, for example, in an avionics bay 2 of the aircraft. In particular, when a control surface is connected to several actuators, for example, two or three actuators, each of said actuators is controlled by a controller connected to a secondary flight control computer distinct from among the set of secondary flight control computers SEC1, SEC2, SEC3. For example, a first actuator is controlled by a controller connected to the computer SEC1 and a second actuator is controlled by a controller connected to the computer SEC2.

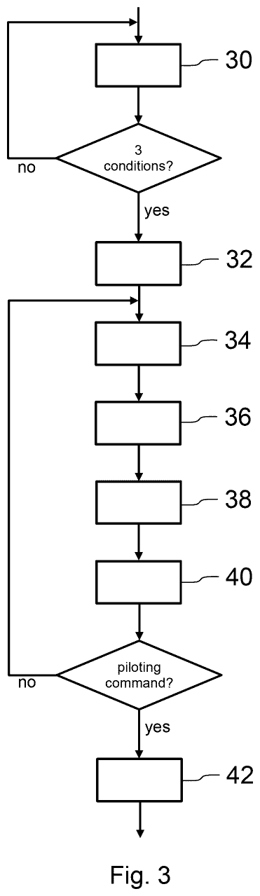

During operation, during a first step 30 of the method illustrated in FIG. 3, each secondary operational flight control computer SEC1, SEC2, SEC3 repetitively determines whether a situation is confirmed, in which the following three conditions are confirmed:
none of the primary flight control computers PRIM1, PRIM2, PRIM3 is functional;
said secondary flight control computer receives valid anemo-inertial information from the aircraft; and
said secondary flight control computer has not received a piloting command originating from at least one piloting component 16 of the aircraft, for at least a predetermined duration.

The first condition, whereby none of the primary flight control computers PRIM1, PRIM2, PRIM3 is functional, is evaluated as in the secondary computers of the prior art, which evaluate this condition in order to determine whether they should take over from the primary flight control computers when they fail. It is based, for example, on exchanging the statuses of the various flight control computers by means of the avionics communication network 14.

The second condition, whereby the secondary flight control computer must receive valid anemo-inertial information from the aircraft, is considered to be met when an anemo-inertial system, for example, of the ADIRU type, forming part of the set of information sources 12 operates and said secondary flight control computer regularly receives information originating from said anemo-inertial system. Preferably, the anemo-inertial information from the aircraft includes at least one current altitude and one current roll angle of the aircraft.

For the evaluation of the third condition, according to which the secondary flight control computer has not received a piloting command originating from at least one piloting component 16 of the aircraft for at least a predetermined duration, said predetermined duration is selected, for example, within a time period of [1 sec; 30 sec], preferably 1 sec.

The secondary flight control computer evaluates these three conditions repeatedly, for example, at a predetermined frequency, as long as they are not confirmed simultaneously. The predetermined frequency is, for example, selected within a period of [0.1 sec; 10 sec], preferably 1 second.

When said three conditions are confirmed, in a second step 32 of the method, the secondary flight control computer activates a particular piloting mode of the aircraft. The secondary flight control computer also acquires information concerning the current altitude of the aircraft and stores a reference altitude corresponding to the value of said current altitude of the aircraft. In particular, the reference altitude is stored in a memory forming part of said secondary flight control computer.

After activating the particular piloting mode in the second step 32, the secondary flight control computer repeatedly implements the following sequence of steps 34, 36, 38 and 40.

In a third step 34, the secondary flight control computer acquires anemo-inertial information from the aircraft originating from the anemo-inertial system, for example, of the ADIRU type, forming part of the set of information sources 12. Preferably, this anemo-inertial information notably includes a current altitude and a current roll angle of the aircraft.

In a fourth step 36, the secondary flight control computer determines current roll and pitch angles of the aircraft based on said anemo-inertial information from the aircraft.

In a fifth step 38, the secondary flight control computer computes control commands for control surface actuators of the aircraft connected to this secondary flight control computer, via their respective controllers, so as to keep the roll and pitch angles of the aircraft at zero values in order to keep the aircraft flat (i.e., horizontal) and at constant altitude.

In a sixth step 40, the secondary flight control computer sends these control commands to the respective controllers of said actuators, so as to control the control surface actuators connected to this secondary flight control computer based on the commands computed in the fifth step 38.

During steps 34, 36, 38 and 40, the secondary flight control computer monitors the possible reception of a piloting command originating from the at least one piloting component 16. As long as no piloting command is received, the secondary flight control computer continues to repetitively implement steps 34, 36, 38 and 40, in particular according to a predetermined frequency, for example, within the period of [10 ms; 1 sec], preferably 0.1 sec. If a piloting command is received, then during a seventh step 42 the secondary flight control computer deactivates said particular piloting mode of the aircraft. This allows an aircraft pilot to resume piloting the aircraft in manual piloting mode. In this case, preferably, the secondary flight control computer no longer subsequently attempts to reactivate said particular piloting mode.

In one embodiment, in the fourth step 36, the secondary flight control computer computes a deviation in altitude Δalti corresponding to a difference between the current altitude of the aircraft and the reference altitude. It also computes a deviation in roll angle corresponding to a difference between the current roll angle of the aircraft and a zero roll angle reference value. This deviation in roll angle therefore is equal to the value of the current roll angle of the aircraft. In the fifth step 38, the secondary flight control computer computes the commands for controlling the control surface actuators of the aircraft in the form of pitch commands and roll commands of the aircraft based on said deviations in altitude and in roll angle, respectively.

In particular, the secondary flight control computer computes the pitch Θtgt and roll Φtgt commands by applying the following formulas:

$$Θ tgt = - k 1 \times Δ alti$$

$$and$$

$$Φ tgt = - k 3 \times Φ$$

in which:
Δalti is said deviation in altitude;
Φ is said deviation in roll angle (equal to the current roll angle);
k1 and k3 are gains, preferably of constant values.

For example, the values of the gains k1 and k3 are adjusted by the aircraft manufacturer so that the pitch and roll angles of the aircraft converge as efficiently as possible toward zero pitch and roll angle values in order to return the aircraft to an attitude in which it flies flat and at constant altitude.

In a particular embodiment, the secondary flight control computer computes the pitch and roll commands in such a way that these commands are homogeneous with piloting commands likely to be issued by the at least one piloting component 16 of the aircraft. In particular, the commands thus computed are homogenized with the signals originating from the piloting component 16, which signals correspond to angular deviations of the piloting component respectively associated with the pitch and roll axes. The secondary flight control computer introduces the pitch and roll commands thus computed at the input of a control chain usually receiving the pitch and roll commands originating from the piloting component 16. This allows this control chain to be reused to compute the commands for controlling the actuators based on the pitch Θtgt and roll Φtgt commands computed by the secondary flight control computer. This thus facilitates the implementation of said particular piloting mode.

In an advantageous embodiment, the pitch command Θtgt is computed taking into account a corrective term designed to avoid oscillations of the pitch angle around a zero pitch angle value Θ=0 when the aircraft is flying substantially at the reference altitude Aref. To this end, in this preferred embodiment, the secondary flight control computer also acquires a current pitch angle Θ, from among the anemo-inertial information originating from the anemo-inertial system, for example, of the ADIRU type.

Avoiding pitch angle oscillations is equivalent to flying with a stabilized pitch angle, i.e., an objective of zero pitch angle variations. A pitch angle speed VΘ is defined as being equal to the derivative of the pitch angle relative to time: VΘ=dΘ/dt.

Consequently, the objective of zero pitch angle variations can be expressed as corresponding to a reference value VΘref of the pitch angle speed that is equal to 0.

A current deviation ΔVθ of pitch angle speed from this reference value is equal to:

$$Δ V Θ = V Θ - V Θ ref$$

$$yet V Θ ref = 0 , therefore :$$

$$Δ V Θ = V Θ = d Θ / dt$$

The corrective term of the pitch angle command is equal to:

$$- k 2 \times Δ V Θ = - k 2 \times d Θ / dt$$

By taking into account this corrective term, the corrected pitch angle command is equal to:

$$Θ tgt = ( - k 1 \times Δ alti ) + ( - k 2 \times d Θ / dt )$$

k2 is a gain, preferably of constant value.

For example, the value of the gain k2 is adjusted by the aircraft manufacturer so that the pitch and roll angles of the aircraft converge as efficiently as possible toward zero pitch and roll angle values in order to return the aircraft to an attitude in which it flies flat and at constant altitude.

Advantageously, the pitch Θtgt and roll Φtgt commands computed by the secondary flight control computer are limited within ranges of defined values in order to limit the reaction dynamics to these commands, so as to avoid excessively sudden reactions of the aircraft. For example, these ranges are defined so as to correspond to commands from the piloting component 16 included in a range of [−18°; +18°] for the pitch axis and in a range of [−20°; +20°] for the roll axis.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A flight control system for an aircraft, the flight control system comprising:
a set of primary flight control computers and a set of secondary flight control computers, wherein each secondary flight control computer is configured to receive operating information from each primary flight control computer, anemo-inertial information from the aircraft, and piloting commands originating from at least one piloting component of the aircraft,
wherein each secondary flight control computer is configured to:
determine whether a situation is confirmed, in which:
none of the primary flight control computers is functional;
said secondary flight control computer receives valid anemo-inertial information from the aircraft; and
said secondary flight control computer has not received a piloting command originating from at least one piloting component of the aircraft, for at least a predetermined duration; and,
when said situation is confirmed, activate a piloting mode of the aircraft, in which said secondary flight control computer is further configured to:
acquire anemo-inertial information from the aircraft;
determine roll and pitch angles of the aircraft based on said anemo-inertial information from the aircraft;
compute control commands for control surface actuators of the aircraft connected to said secondary flight control computer so as to maintain the roll and pitch angles of the aircraft at zero values in order to keep the aircraft flat and at constant altitude; and
control the control surface actuators connected to said secondary flight control computer based on the computed control commands.

2. The flight control system as claimed in claim 1, wherein said secondary flight control computer is further configured to deactivate said piloting mode after activating said piloting mode, when said secondary flight control computer receives at least one piloting command originating from the at least one piloting component of the aircraft.

3. The flight control system as claimed in claim 1, wherein said anemo-inertial information from the aircraft comprises at least one current altitude and one current roll angle of the aircraft, and
wherein each secondary flight control computer is further configured to:
store a reference altitude corresponding to a current altitude of the aircraft when said piloting mode is activated;
compute a deviation in altitude corresponding to a difference between the current altitude of the aircraft and the reference altitude;
compute a deviation in roll angle corresponding to a difference between the current roll angle of the aircraft and a zero roll angle reference value; and,
compute the control commands for the control surface actuators of the aircraft as pitch commands and roll commands of the aircraft based on said deviations in altitude and in roll angle, respectively.

4. The flight control system as claimed in claim 3, wherein the pitch and roll commands are computed by said secondary flight control computer so as to be homogeneous with piloting commands likely to be issued by the at least one piloting component of the aircraft, and
wherein said secondary flight control computer is configured to apply the pitch and roll commands thus computed to an input of a control chain of said secondary flight control computer configured to receive piloting commands originating from the at least one piloting component of the aircraft.

5. The flight control system as claimed in claim 3, wherein said secondary flight control computer is further configured to compute the pitch commands taking into account a corrective term intended to control a zero pitch speed of the aircraft.

6. The flight control system as claimed in claim 3, wherein said secondary flight control computer is further configured to limit each of the pitch commands and the roll commands between a minimum value and a maximum value, the minimum value and the maximum value, respectively, corresponding to permissible minimum and maximum limits of values of piloting commands originating from the at least one piloting component of the aircraft.

7. A method for controlling a flight of an aircraft which comprises a flight control system comprising a set of primary flight control computers and a set of secondary flight control computers, wherein each secondary flight control computer is configured to receive operating information from each primary flight control computer, anemo-inertial information from the aircraft and piloting commands originating from at least one piloting component of the aircraft, and
wherein the method comprises the following steps implemented by each secondary flight control computer:
determining whether a situation is confirmed, in which:
none of the primary flight control computers is functional;
said secondary flight control computer receives valid anemo-inertial information from the aircraft; and
said secondary flight control computer has not received a piloting command originating from the at least one piloting component of the aircraft, for at least a predetermined duration;
when said situation is confirmed, activating a piloting mode for the aircraft comprising the following steps:
acquiring anemo-inertial information from the aircraft;
determining roll and pitch angles of the aircraft based on said anemo-inertial information from the aircraft;
computing control commands for control surface actuators of the aircraft connected to said secondary flight control computer so as to maintain the roll and pitch angles of the aircraft at zero values in order to keep the aircraft flat and at constant altitude; and
controlling the control surface actuators connected to said secondary flight control computer based on the computed control commands.

8. The method as claimed in claim 7, wherein, with said anemo-inertial information from the aircraft comprising at least one current altitude and one current roll angle of the aircraft, the method further comprises the following steps implemented by the secondary flight control computer:
storing a reference altitude corresponding to a current altitude of the aircraft when said piloting mode is activated;
computing a deviation in altitude corresponding to a difference between the current altitude of the aircraft and the reference altitude;
computing a deviation in roll angle corresponding to a difference between the current roll angle of the aircraft and a zero roll angle reference value; and
computing the control commands for the control surface actuators of the aircraft as pitch commands and roll commands of the aircraft based on said deviations in altitude and in roll angle, respectively.

9. The method as claimed in claim 8, wherein the step of computing the control commands of the actuator comprises computing the pitch commands taking into account a corrective term intended to control a zero pitch speed of the aircraft.

10. An aircraft comprising:
a flight control system as claimed in claim 1.
